(19) United States
(12) Patent Application Publication
(10) Pub. No.: US 2013/0201797 A1
(43) Pub. Date: Aug. 8, 2013

(54) kF.

(71) Applicant: Alfred M. Haas, Oakhurst, NJ (US)

(72) Inventor: Alfred M. Haas, Oakhurst, NJ (US)

(21) Appl. No.: 13/740,767

(22) Filed: Jan. 14, 2013

Related U.S. Application Data
(60) Provisional application No. 61/586,838, filed on Jan. 15, 2012.

(51) Int. Cl. G01S 3/80

(52) U.S. Cl. CPC G01S 3/80
USPC 367/118

(57) ABSTRACT

The invention disclosed herein relates to methods and means for locating entities, places and/or things. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS

Pursuant to 35 USC §119(e) and as set forth in the Application Data Sheet, this utility application claims the benefit of priority from U.S. Provisional Patent Application No. 61/586,838 (“the '838 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '838 provisional and expressly incorporates by reference the disclosures contained therein in their entirety, including but not limited to all patents, patent applications, and publications which are incorporated by reference in the '838 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system, etc . . . Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: e-readers (e.g. Kindle™ and Nook™), hearing aids, laptop and desktop computers, alarms, smart phones, PDAs, other commercially available electronic devices such as tablet PCs, netbooks, pagers, beepers, cell phones, hearing aids, watches comprising integrated and/or discrete circuits, monitors and displays, televisions, calculators, iPods™ and MP3 players, radios and stereos, speakers, microphones, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, digital signal processors, memories, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, coils, radio frequency identification (“RFID”) devices, near-field communication (“NFC”) devices, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, etc . . . .

Examples of commercial-off-the-shelf hardware, including but not limited to processing units, displays, microphones, sensors, and speakers may be found on the DigiKey website, “http://www.digikey.com” , the Allied Electronics website, “http://www.alliedelec.com”, and the website “http://www.globalspec.com”. Details pertaining to these sensors may be found in their associated sensor and product data sheets and published specifications which are incorporated herein by reference.

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, and other aspects of embodiments of the disclosed invention—including, but not limited to, software and hardware such as sensors and transducers, circuits, transmitters, receivers, housings, wearable and other mobile devices, optics, programmable logic elements and chips, custom ASICs, electrical and mechanical switches, electrical and mechanical regulators, etc.: Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The invention disclosed herein relates to methods and means for locating entities, places and/or things.

### BRIEF DESCRIPTION OF THE SEVERAL VIEWS OF THE DRAWING

FIGS. 1A and 1B show a schematic view of one specific example of a locator device according to some embodiments of the invention.

FIG. 2.A shows a cartoon image of a specific example of an embodiment of a locator device comprising a vehicle.

FIG. 2.B shows another image of the vehicle shown in FIG. 2.A in a parking space of a parking lot.

FIG. 2.C illustrates one specific example of an embodiment of a method of the invention wherein a user locates a vehicle.

FIG. 3.A shows a specific example of an embodiment of the invention comprising a cell phone locator device.

FIG. 3.B shows a cartoon of a specific example wherein a user employs an embodiment of a locator device according to an embodiment of one of the methods of the instant invention.

FIG. 3.C shows a cartoon of another specific example wherein a user employs an embodiment of a locator device according to an embodiment of one of the methods of the instant invention.

FIG. 4 depicts a specific example wherein a child is located and rescued according to some embodiments of the methods and means of the invention.

FIG. 5 illustrates several specific examples of some embodiments of the methods and means of the instant invention wherein an individual is attempting to locate a restroom.

FIG. 6 illustrates a schematic of a specific example of a method to compute inferred proximity and direction of an incident signal relative to a locator device according to some embodiments of the instant invention.

### DETAILED DESCRIPTION OF THE INVENTION

The invention disclosed herein relates to methods and means for locating entities, places and/or things.

Although it is not believed that drawings are necessary for the understanding of the subject matter sought to be patented, for illustrative purposes we have included several figures related to specific examples of embodiments of the disclosed invention.

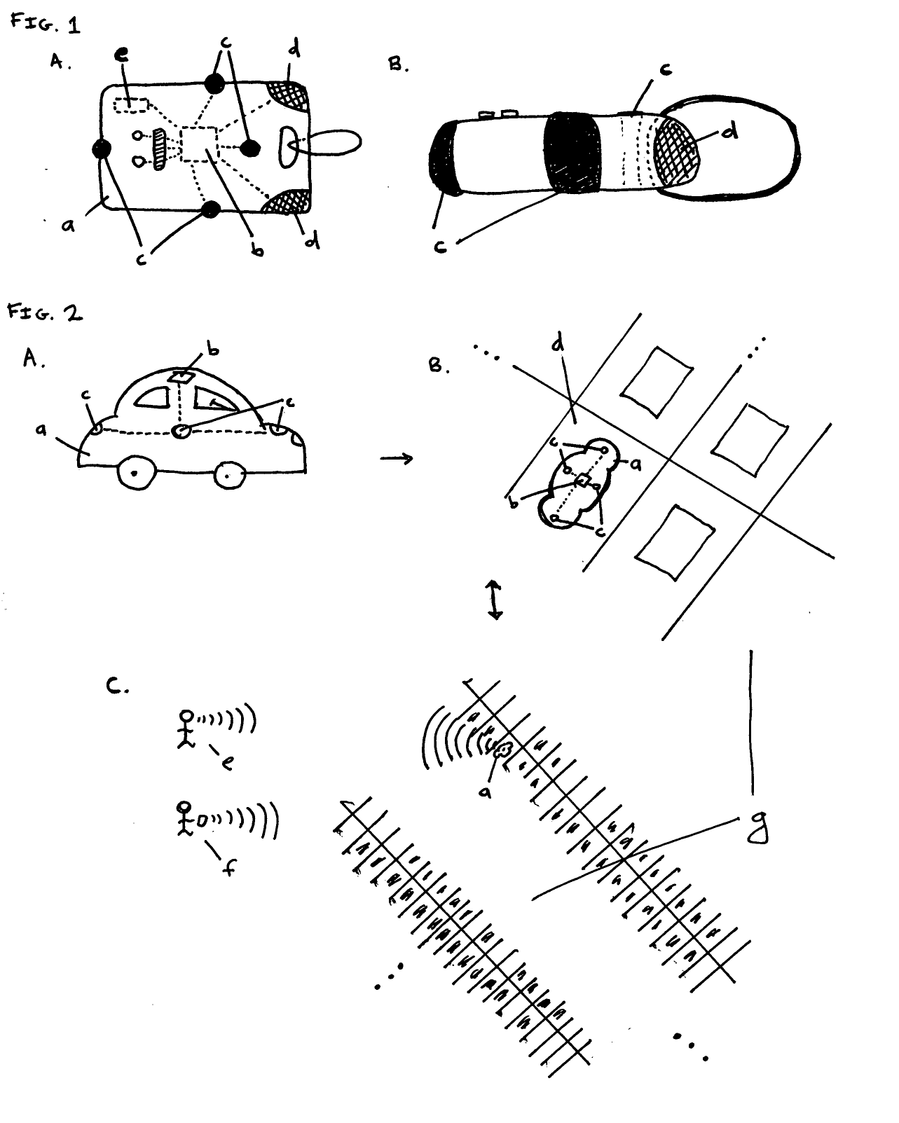

FIG. 1.A shows a top down schematic view of one specific embodiment of the invention, comprising: (a) a housing having an interior region and an exterior surface; (b) a processing unit; (c) means for transducing sound into an electrical signal; (d) a transmitter; and (e) a power supply. In this specific illustration, the locator device comprises a key fob additionally comprising an unlabeled key ring and buttons for user input. A housing may comprise almost any material composition. In some embodiments, all or part of a housing may be conformal, flexible, malleable, moveable, pliable, plastic, rubbery, and/or stretchable. Illustrative examples of materials that may comprise a housing include but are not limited to: glass, plastic, ceramic, silicone and/or rubber, stone, crystal, wood, metal and metal alloys (e.g. aluminum, steel, stainless steel, iron, copper, titanium, etc . . . ), other polymers (e.g. ABS, polyethylene, etc.), and other composite materials (e.g. carbon fiber). In some embodiments, a housing may be sealed, water proofed, water-resistant, air-tight, permeable, semi-permeable, and/or have openings. In some embodiments, the interior region of a housing may be further compartmentalized, divided, or otherwise separated into different regions, each of which may be sealed, water proofed, water-resistant, air-tight, permeable, semi-permeable, and/or have openings. Permeable and semi-permeable may refer in this context to air, gases, water, or any other substances, e.g., odorants, ions, sugars, and/or other fluids and/or solids.

The processing unit, (b), of the specific embodiment schematically represented in FIG. 1 comprises hardware and/or software for ascertaining and/or computing the proximity and/or relative location of a user and/or a tag device with respect to the locator device. In some embodiments of the invention, processing units comprise microcontrollers. In some embodiments, a processing unit may comprise one or more of a display driver, speaker drivers, input channels, power conditioning circuits, memory, and power supply regulation circuitry. In some embodiments, a processing unit may comprise additional hardware and/or software for performing other functions including but not limited to processing and transmitting data, processing and transmitting power, storing and retrieving data, receiving and decoding voice commands, generating signals including but not limited to text, graphics, and speech, as well as for such miscellaneous functions as, e.g. waking and sleeping. In some embodiments, a processing unit comprises custom integrated circuits; in some embodiments the processing unit comprises discrete circuits. In some embodiments, a processing unit comprises a combination of hardware and/or software.

In some embodiments of the invention, a processing unit comprises a communications module—for example, a transceiver with antenna for communicating with other circuits, components, devices, systems, networks and individuals. In some embodiments, a communications module may be used to transmit and receive data such as, e.g. a signal from an RF transmitter, digital GPS coordinates, or user data such as recorded voice samples, firmware and software updates, as well as other data (e.g., the time and date, weather conditions, etc . . . ). In some embodiments, a communications module may comprise an antenna and/or coil for transmitting and/or receiving EM signals. A communications module may be integrated with the processing unit and/or comprise a separate component that may in some embodiments communicate with the processing unit. A communications module may communicate wirelessly along one or more wavelengths of the electromagnetic spectrum, including but not limited to, radio waves, IR, and visible light (e.g. via radio transceiver, IR transceiver, other coded and/or modulated light transmissions, etc . . . ). It may also communicate via wires which are not illustrated, for example using one of a variety of USB cables. In addition, a communications module may include speakers and/or microphones and associated circuits for receiving and decoding voice commands and for generating sounds, including but not limited to speech. A communications module may also be integrated with the power supply—for example by capturing, harvesting and/or storing ambient or transmitted energy from an EM signal.

In FIG. 1, the sound transducing means, (c), is depicted without loss of generality as an array of four directional microphones. However, some embodiments of the means of the instant invention may comprise any number of microphones, including no microphones. In the context of this disclosure, microphones are defined according to their plain and ordinary meaning and specifically meant to include, but not be limited to, electrostatic microphones, dynamic microphones, carbon microphones, piezoelectric microphones, microphones which employ light to transduce sound into an electrical signals such as fiber optic and laser microphones, fluid-based sound transduction mechanisms such as liquid microphones, micro-electro-mechanical and nano-electro-mechanical microphones, and other devices that may be used to transduce sound into an electrical signal. In some embodiments microphones may be omnidirectional; in some embodiments microphones may be unidirectional; in some embodiments, microphones may transduce sound according to some other directional pattern. In some embodiments, microphones may be integrated; in some embodiments, microphones may be discrete. In some embodiments, microphones may comprise commercial-off-the-shelf components, in some embodiments, microphones may be assembled, constructed, cut, etched, deposited, fabricated, formed, and/or otherwise made. In some embodiments, microphones may comprise speakers, headphones and/or headsets. In some embodiments, microphones may comprise housings for modulating and/or filtering sound including but not limited to microphone housings, apertures, channels, waveguides, and filters.

The transmitter, (d), of the specific embodiment schematically illustrated in FIG. 1 comprises a speaker for transmitting and/or broadcasting sound. In some embodiments, a transmitter may comprise RF or other EM transmission means for communicating and/or interfacing with other circuits, components, devices, systems, networks and individuals. In some embodiments, a transmitter comprises a means for producing vibration and/or low frequency compression waves, for example vibrating motors.

In some embodiments, a transmitter may comprise one or more lights, including but not limited to arrays of lights such as an LCD or LED display. For example, some embodiments comprise OLED (organic light emitting diode) screens like those found in modern cell phones and tablet PCs. However, as used in the context of this invention, displays are not intended to be limited to a single or even to existing technology—at the time this specification was written, additional examples of displays comprised, but were not limited to, the following: liquid crystals, thin film transistors, incandescent lights, fluorescent lights, halogen lights, light emitting diodes, organic light emitting diodes, lasers, fiber optics, color-changing polymers, pigmented fluids, solutions and mixtures, functionalized micro-beads, and e-inks

The power supply, (e), of the specific embodiment schematically illustrated in FIG. 1 comprises a battery holder and rechargeable batteries. Additional illustrative examples of a power supply include, but are not limited to, a battery holder, solar cells and associated charging circuitry, a plug for receiving wall power with or without associated circuitry (such as electrical transformers, rectifiers, voltage regulators, capacitors, etc.), an inductive power receiver element (such as a coil and circuitry to receive inductively coupled power), an electromechanical generator (think self-winding watch), a thermal generator (think MEMS/NEMS generators), and any other suitable source of power.

In FIG. 1.A, dotted lines represent internal wired communications buses between the components of this specific embodiment of a locator device, although such communications buses may be virtual—i.e. communicating via EM transmission.

FIG. 1.B shows a side view of the specific example of an embodiment of a locator device shown in FIG. 1.A with labeled microphones (including one hidden from view from this angle), (c), and speaker, (d), and unlabeled buttons, housing and key ring.

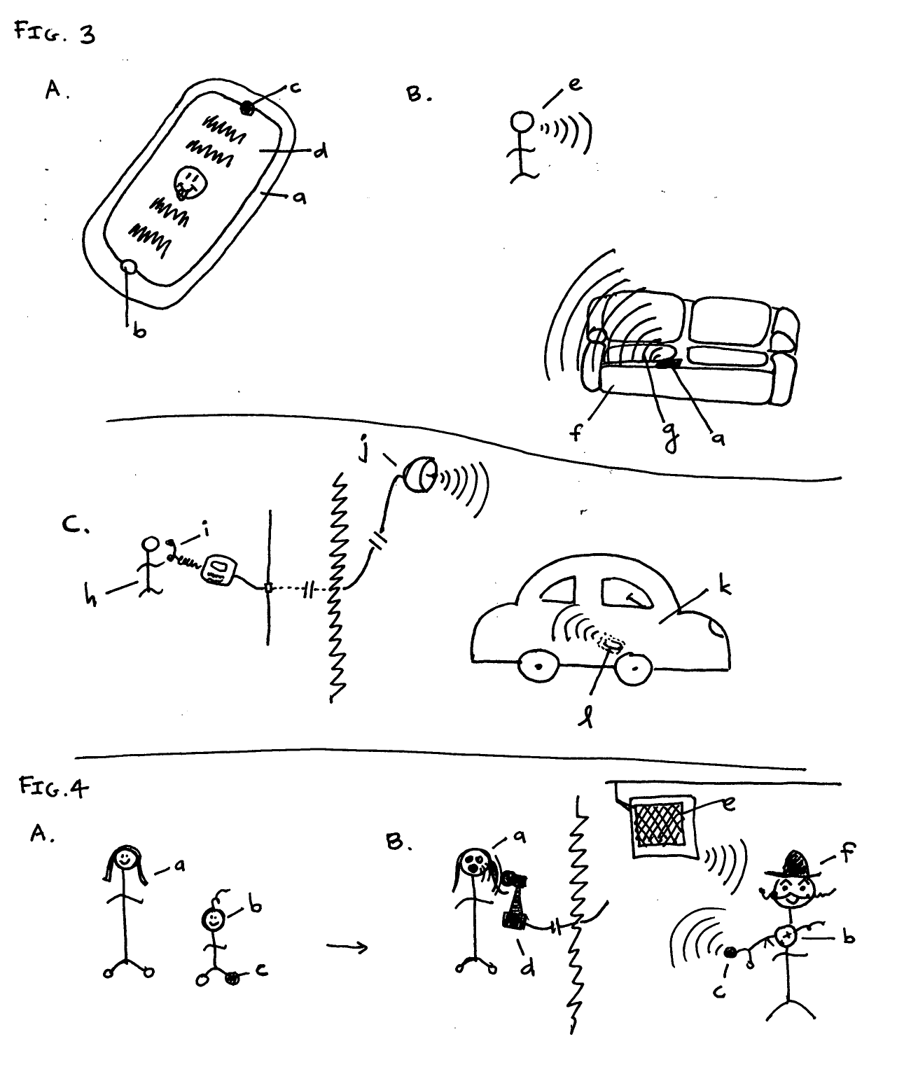

FIG. 2.A shows a cartoon image of a specific example of an embodiment of a locator device comprising a vehicle, (a), a processing unit, (b), and means for detecting and/or transducing a signal, (c), including but not limited to sound and/or any form of EM radiation, into an electrical signal. In this figure the locator device further comprises a power supply and transmitter which are not explicitly drawn. FIG. 2.B shows the vehicle of the specific example of an embodiment, (a), in a parking space, (d), of parking lot (g) shown in greater detail in FIG. 2.C. FIG. 2.C illustrates one specific example of an embodiment of a method of the invention comprising the steps of a user, (e), either speaking or shouting, and/or a device, (f), transmitting a signal that is detected and processed by the locator device, (a), and the locator device generating and transmitting a signal to the user and/or to a device possessed by and/or in close proximity to the user indicating the relative location of the vehicle.

FIG. 3.A shows a specific example of an embodiment of the invention comprising a cell phone locator device, (a), having an integrated microphone, (b), camera, (c), and display, (d). FIG. 3.B shows a cartoon of a specific example of an embodiment of the instant invention wherein a user, (e), calls out to his cell phone, (a), stuck under seat cushion, (g), of sofa, (f), and wherein the cell phone locator device, (a), generates and transmits a speech signal to the user indicating its relative location and condition—e.g. “5 feet to the left, possibly under something.” FIG. 3.C, illustrates a cartoon of another specific example of an embodiment of the instant invention wherein a different user, (h), uses a landline telephone, (i), to call his cellular telephone in this specific example, via (landline to local network hub to network transceiver to) satellite transceiver, (j), to cell phone, (l), on the floor of vehicle, (k), which cell phone locator device then detects the incoming call, wakes from power conservation mode, and transmits its GPS coordinates across a wireless network to the user.

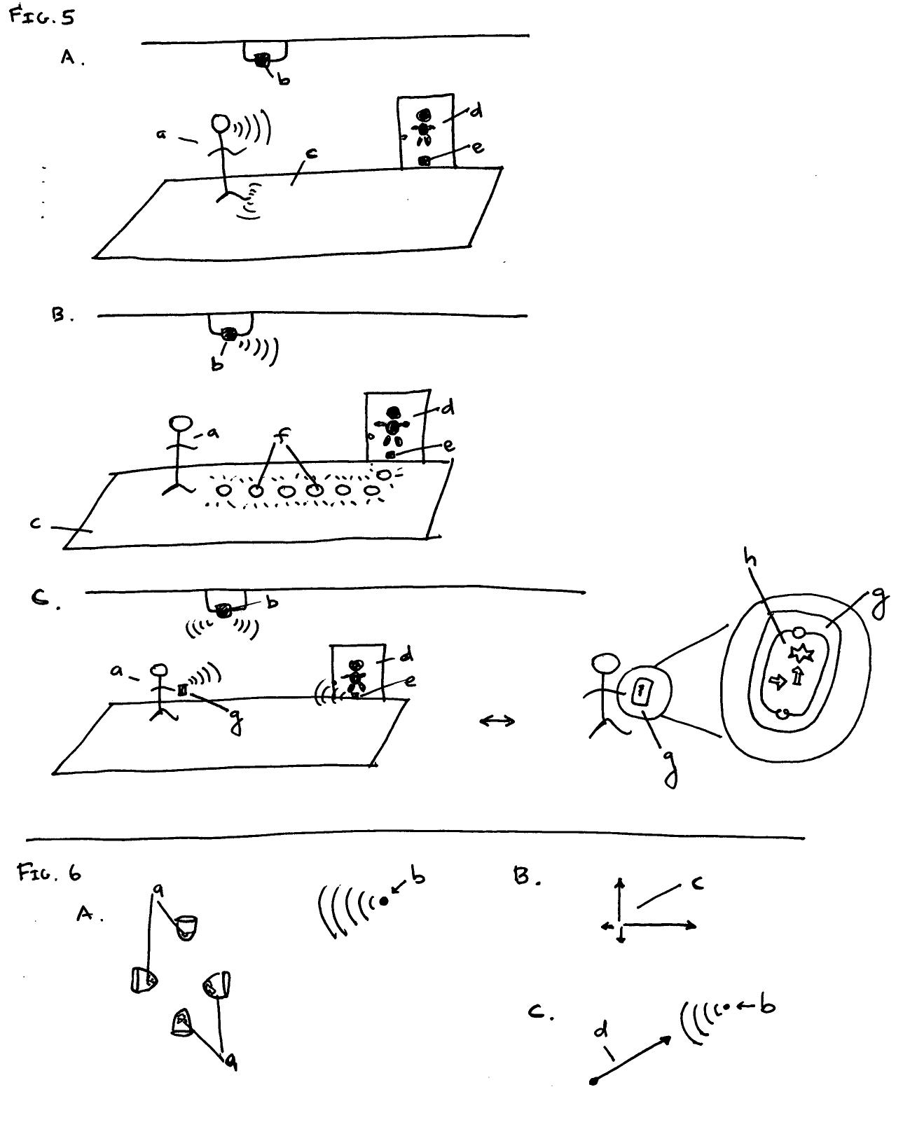

FIG. 4 depicts yet another specific example of an embodiment of the instant invention wherein a child's, (b), sneaker, (c), comprises a locator device. In the sequence of panels, a child, (b), and his mother, (a), are shopping in a local mall when the child wanders off and is abducted by the man with the sinister moustache wearing the dark hat, (f). The panicked mother, (a), cries out, but the child, (b), is out of earshot and possibly unconscious so the panicked mother, (a), uses a public address system, (d), (e), to call out to the locator device, (c), which recognizes her voice and the distress in her tone and sounds an alarm. Fortunately, nearby shoppers and security staff hear the alarm and rescue the child.

FIG. 5 illustrates additional examples of some embodiments of the instant invention. In FIGS. 5.A and 5.B, a dance club patron, (a), looking for the restroom, (d), inquires aloud “Where is the men's room?” and a signal transducing means, (b), detects his inquiry and in conjunction with a locator device, (e), embedded in the door of the restroom (perhaps in a door knob) filters and processes his inquiry and directs him to the restroom using a display, (c), embedded in and/or comprising the dance club floor, by generating a path of lighted elements, (f), on the floor from the ascertained, computed and/or inferred location of the patron, (a), to the location of the restroom, (d). In FIG. 5.C the patron uses a hand held locator device (and/or tag)—e.g. a cell phone locator device, (g), to communicate with transceiver, (b), and locator device (e), to find the nearest men's room, whereupon locator device, (e), transmits the men's room coordinates to the patron's hand held device, (g), which ascertains, computes and/or infers the patron's location with respect to the restroom and directs the user to his desired destination via graphic instructions on display, (h), of the hand held device, (g). In some embodiments, impedance sensing means, capacitive sensing means, pressure sensing means, optical sensing means, and/or other sensing means in the floor (or for optical sensing means in the walls, ceiling, or otherwise situated in or moveable to—e.g. camera on an RF helicopter, or a sliding dolly or rail—an area) might be used in conjunction with other hardware and/or software to ascertain and/or compute the position and/or location of a person in an area.

FIG. 6 illustrates one specific and rudimentary method by which it may be possible to compute inferred proximity and direction of an incident signal relative to a locator device according to some embodiments of the instant invention. FIG. 6.A schematically illustrates a quartet (4) of substantially unidirectional microphones, (a), that are or may be fixed relative to one another, and also a sound wave with origin, (b). FIG. 6.B illustrates a hypothetical vector representation, (c), of the relative magnitude of the signals transduced by each of the four microphones arising from the sound, (b), with the direction of each of the vectors corresponding with the direction of the corresponding microphone and the magnitude of each vector corresponding with the strength of the signal transduced by the corresponding microphone. FIG. 6.C illustrates the vector sum , (d), of all four vectors in 6.B, which vector sum points in the direction of the origin of the sound, (b), and has a magnitude proportional to the volume of the sound at its origin and to the proximity of the origin of the sound to the microphones.

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A means comprising hardware for locating entities, places and/or things.

2. The means of claim 1 wherein the hardware comprises one or more of a cell phone, a tablet computer, a worn device comprising a microprocessor, and a personal digital assistant.

3. A method for locating entities, places and/or things.

4. The method of claim 3 wherein one or more steps of the method involves the use of hardware comprising one or more of a cell phone, a tablet computer, a worn device comprising a microprocessor, and a personal digital assistant.
